(19) United States
(12) Patent Application Publication
(10) Pub. No.: US 2005/0167037 A1
(43) Pub. Date: Aug. 4, 2005

(54) Method and article for decorating model racing cars

(76) Inventor: C. Dwayne Fulton, Osage Beach, MO (US)

Correspondence Address: STINSON MORRISON HECKER LLP;ATTN: PATENT GROUP, 1201 WALNUT STREET, SUITE 2800, KANSAS CITY, MO, 64106-2150, US

(21) Appl. No.: 10/770,135

(22) Filed: Feb. 2, 2004

(51) Int. Cl. B44C 1/165; B32B 9/00; B32B 31/00; B32B 33/00

(52) U.S. Cl. 156/230; 156/267; 428/40.1

(57) ABSTRACT

A Method and Article for Decorating a Model Racing Car is disclosed. The article comprises a sheet holding a transferable design and comprising a film layer with a printed design which is sized to cover substantially the entire body of a model racing car. The layer of pigmented adhesive covers one side of said film and a release sheet is adhered to this pigmented adhesive layer. A water absorbent sheet covers the side of the film opposite the above-referenced adhesive layer and includes a water soluble adhesive layer which adheres to the design carrying film. The method includes removing the release sheet to expose the pigmented adhesive layer which is then placed over the car body. A quantity of water sufficient to dissolve the adhesive on the back side of the water absorbent sheet is then applied so that this sheet can also be removed. The design carrying film is then conformed to the shape of the model racing car and excess material is trimmed away using a knife.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

This invention relates to model racing cars of the type that are especially popular with use for racing in a Pinecar® Derby.

These cars are usually hand painted and, in some cases, decorated with decals. The deficiencies of the present decorating techniques include inconsistency, almost complete dependence upon the skill of an individual (which varies considerably especially at young ages), and a limited number of relatively simple designs which can be accomplished.

1. Field of the Invention

The present invention addresses the problems of decorating model racing cars according to the prior art by providing a method and article for decorating which provides greater consistency, is less dependent upon the skill of an individual, and increases the number of possible designs which can be used.

2. Description of Related Art

It is known to hand paint designs onto model racing cars. It is also known to apply decals at selected locations to enhance the appearance of a model racing car.

### BRIEF SUMMARY OF THE INVENTION

The present invention provides a method and article for decorating a model racing car where a sheet holding a transferable design covers substantially the full body of the car and is then trimmed to the exact size and shape desired.

Another important aim of the invention is to provide a method and article for decorating a model racing car wherein a sheet holding a transferable design covers substantially the entire body of the car and does not have to be of a repetitive pattern.

It is therefore an objective of the present invention to provide an improved method and article for decorating a model racing car which will provide the car with a more professional appearance than can be achieved by hand painting.

It is also an aim of this invention to provide a method and article for decorating a model racing car which can employ more complicated designs than would be possible with hand painting.

Another object of the invention is to provide a method and article for decorating a model racing car which provides for a greater variety of designs than is practical using hand painting techniques.

Another very important object of this invention is to provide a method and article for decorating a model racing car which allows participants in organized derby racing who are less artistic to compete with those participants who are more artistically talented.

A particular advantage of the invention is that nonrepetitive or random patterns can be applied to decorate the car rather than being limited to repetitive patterns. Repetitive patterns may also be utilized but are not preferred.

### BRIEF DESCRIPTION OF THE DRAWINGS

Other objects of the invention will be made clear and become apparent from the following descriptions and claims when read in light of the accompanying drawings wherein:

FIG. 1 is a perspective view of a model racing car block for use in the method of the present invention;

FIG. 2 is a perspective view of the article which is employed in the method of the invention to achieve full body decoration with two layers of the laminate pulled partially away;

FIG. 3 is a greatly enlarged cross sectional view of the article shown in FIG. 3 with one layer pulled partially away from the other two layers.

FIGS. 4, 5 and 6 illustrate the method of decorating a model racing car utilizing the article of the present invention; specifically, FIG. 4 shows the transfer sheet applied to the car after the adhesive release sheet has been removed. This figure also shows water being applied to accomplish transfer of the design;

FIG. 5 is another perspective view showing the protective layer being removed from the design layer; and

FIG. 6 illustrates the design article on model car being trimmed to the exact size and configuration desired.

### DETAILED DESCRIPTION OF PREFERRED EMBODIMENT

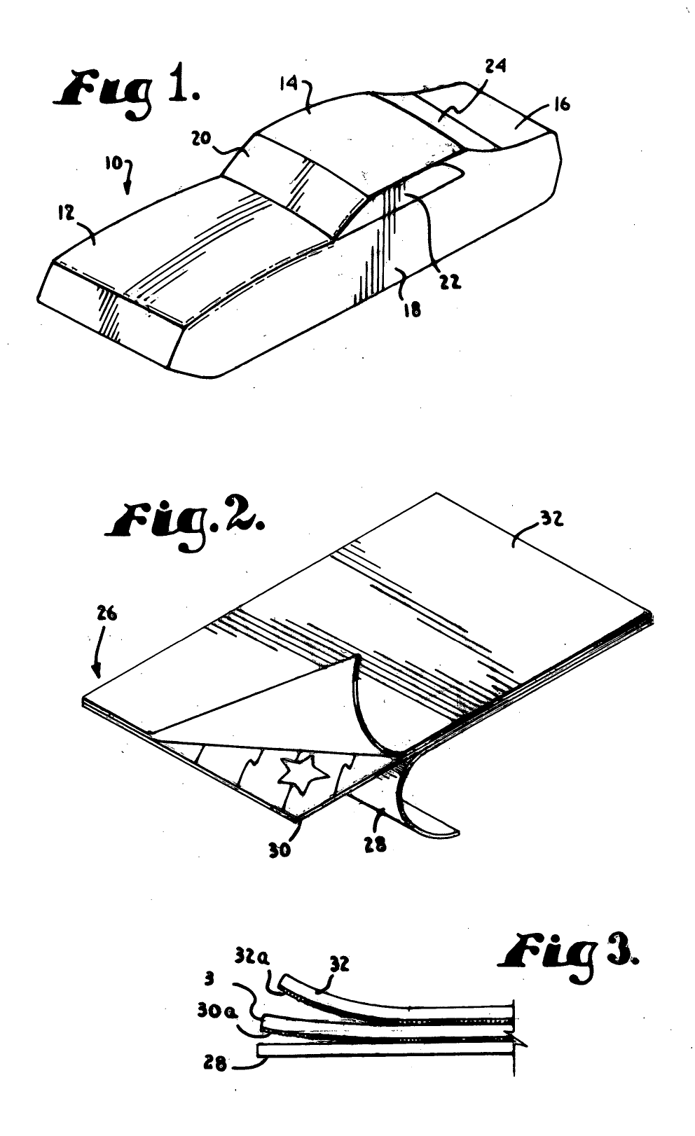

Referring initially to FIG. 1, a model racing car body is designated generally by the numeral 10 and is typically formed from a block of wood. The body of the car includes an engine area 12, a roof area 14, a trunk section 16 and side body portions 18, only one of which is visible in FIG. 1. A front windshield area is designated by the numeral 20. Also included are two side window areas 22 (one of which is visible in FIG. 1) and a rear window area 24.

Referring now to FIG. 2, a transfer sheet holding a printed design for decorating car 10 is designated generally by the numeral 26. Sheet 26 comprises three basic layers. A first release sheet 28, a design carrying layer 30 and a second release sheet 32 formed from a water absorbent material.

Further details of the construction of sheet 26 are illustrated in the greatly enlarged cross sectional view, FIG. 3. The design carrying printed film 30 includes an underlying layer of pigment and adhesive 30a. The preferred pigment is titanium dioxide so as to present a white appearance. Sufficient pigment is included in the adhesive to result in an opaque background when film 30 is applied to car 10. Alternatively, the opaque background may be provided by a separate pigmented layer. In this case the opaque layer would be adhered to film 30 and adhesive layer 30a would be on the opposite side of the opaque layer from film 30. First release sheet 28 adheres to the pigmented adhesive layer 30a. The second release sheet 32 includes a water soluble adhesive 32a so that it will adhere to the printed film 30.

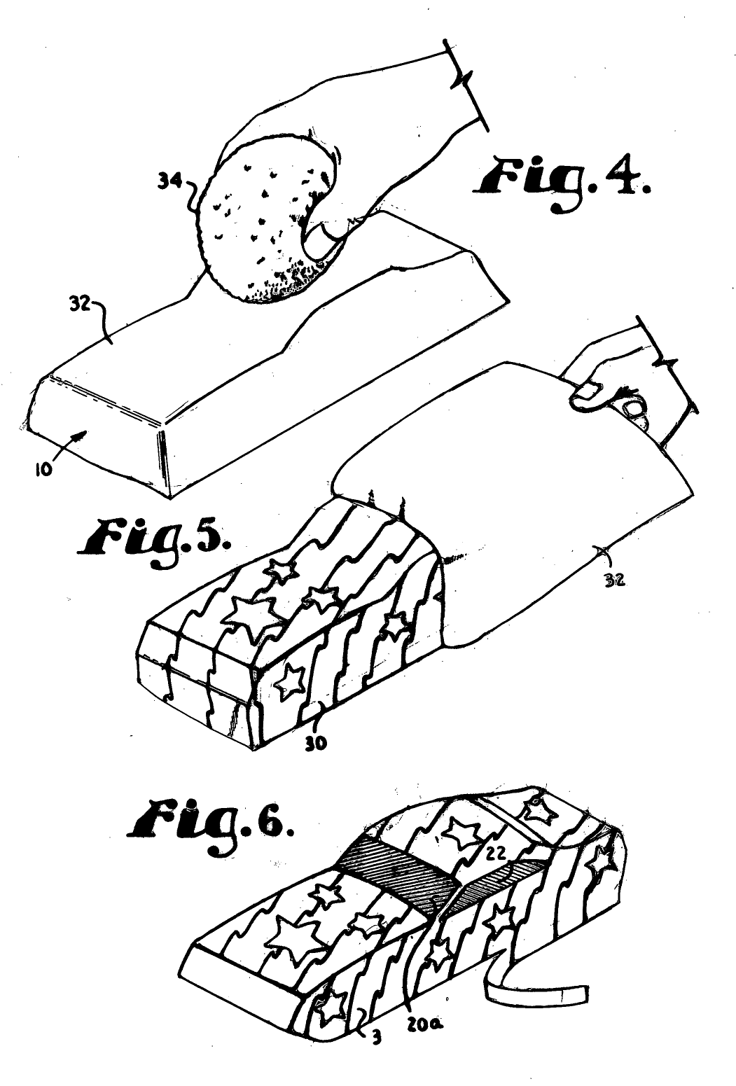

The method according to present invention will also describe the use of transfer sheet 26. The first step is to provide the sheet having the components described above. Next, first release sheet 28 is peeled away in the manner illustrated in FIG. 2. As shown in FIG. 4, sheet 26 is of a size to completely cover and extend slightly beyond the perimeter of car body 10. Once the first release sheet 28 has been peeled away, the remainder of the transfer sheet is placed on the car body and generally conformed to the shape of the car as illustrated in FIG. 4. This is done with the adhesive pigmented layer 30a next to the car body. The adhesive used for this layer is nonwatersoluble. The next step is to utilize a sponge 34 to transfer a sufficient amount of water to the top side of sheet 26. The second release sheet 32 is formed from a water absorptive paper material. The adhesive layer 32a on the back side of release sheet 32 is water soluble and once wet will allow sheet 32 to be pulled away from the film layer 30 in the manner illustrated in FIG. 5. Once sheet 32 is completely removed, a knife 36 is utilized to trim sheet 30 to the exact configuration of car body 10. A windshield simulating overlay 20a is placed over sheet 30 in the area of windshield 20 to simulate a windshield in the completed car.

The presence of pigmented adhesive layer 30a assures that the image which is printed on film 30 will be well defined and brilliant. While pigments other than titanium dioxide may be employed it is important the pigment provide an opaque background which will enhance the design rather than mask it. This increases the sharpness and brilliance of the design. While the invention has been described with reference to a single sheet being applied to the model car block it is to be understood that in some instances the sheet may be cut into two or more sections before application. For example, the sides may be cut out and applied separately from the remainder of the body to reduce potential wrinkling and make the application process easier. This would not be practical with other than a nonrepetitive design.

It will also be appreciated that the invention contemplates applying a transfer sheet to a car made of a translucent body in which case the adhesive layer which joins the printed film to the body will be clear and an opaque non-adhesive layer will be formed on the backside of the printed film. In this instance the printed film and opaque background layer are applied to the inside of the translucent body.

From the foregoing it will be seen that this invention is one well adapted to attain all ends and objectives herein-above set forth, together with the other advantages which are obvious and which are inherent to the invention.

Since many possible embodiments may be made of the invention without departing from the scope thereof, is to be understood that all matters herein set forth or shown in the accompanying drawings are to be interpreted as illustrative, and not in a limiting sense.

While specific embodiments have been shown and discussed, various modifications may of course be made, and the invention is not limited to the specific forms or arrangement of parts and steps described herein, except insofar as such limitations are included in the following claims. Further, it will be understood that certain features and sub-combinations are of utility and may be employed without reference to other features and sub-combinations. This is contemplated by and is within the scope of the claims.

1. A method of decorating a model car comprising the steps of:
providing a sheet of decorating material which holds a transferable image which is of a size to envelope said car and overlap the edge;
applying said sheet to said car;
transferring said image to said car; and
trimming excess material away whereby the remaining material conforms to the configuration of said car.

2. A method as set forth in claim 1, wherein said transferring step comprises a wet transfer process.

3. A method as set forth in claim 2, wherein said step of providing a sheet of decorating material includes providing a sheet having an opaque background.

4. A method as set forth in claim 3, wherein said opaque background comprises a pigmented adhesive.

5. A method as set forth in claim 1, wherein said sheet is characterized by a nonrepetitive pattern.

6. A method as set forth in claim 5, wherein said applying step comprises cutting said sheet into multiple pieces and applying the pieces individually.

7. A method as set forth in claim 1, wherein said sheet is applied to the exterior of said car.

8. A sheet of decorating material holding a transferable design and adapted to be applied to substantially the full body of a model racing car, said sheet comprising:
a first film having a design printed on it and sized to cover a model racing car;
an opaque layer covering one side of said film, said opaque layer including a layer of adhesive;
an adhesive layer adjacent said opaque layer;
a release sheet covering said adhesive on said opaque layer;
a water absorbent sheet covering the side of said first film opposite said adhesive layer;
said water absorbent sheet having a water soluble second adhesive layer adhered to said film.

9. The invention of claim 8, wherein said opaque layer is incorporated into said adhesive layer to form a pigmented adhesive.

10. The invention of claim 8, wherein said design is a nonrepetitive pattern.
